(19) United States
(12) Patent Application Publication
(10) Pub. No.: US 2020/0410451 A1
(43) Pub. Date: Dec. 31, 2020

(54) EXTRACTING TITLE HIERARCHY FROM TRAJECTORY DATA

(71) Applicant: Microsoft Technology Licensing, LLC, Redmond, WA (US)

(72) Inventor: Varun Mithal, Sunnyvale, CA (US)

(21) Appl. No.: 16/455,251

(22) Filed: Jun. 27, 2019

(51) Int. Cl. G06Q 10/10; G06F 16/901; G06F 16/2457

(52) U.S. Cl. CPC G06Q 10/1053; G06F 16/24578; G06F 16/9024

(57) ABSTRACT

Disclosed are systems, methods, and non-transitory computer-readable media extracting title hierarchy from trajectory data. A computing system generates a title hierarchy using a graph of connected nodes generated based on career trajectory data. Each distinct node in the graph represents a unique employment title identified in the career trajectory data. Connections established among pairs of nodes in the graph indicate user transitions among the employment titles associated with the nodes and edge values assigned to the connections indicate the number of users that transitioned from the employment titles associated with the nodes in the pair of nodes. The edge values are used to assign seniority values to each node in the graph, for example, by performing a topological sort of the nodes in the graph. The seniority values are used to establish the title hierarchy.

### TECHNICAL FIELD

An embodiment of the present subject matter relates generally to title hierarchy and, more specifically, to extracting title hierarchy from trajectory data.

### BACKGROUND

Some online services provide career services, such providing a listing of job postings for open employment positions. Users may use the online service to review the listings and apply to open positions of interest. To provide additional value, some online services may provide users with recommendations of open positions that may be of interest to the users. In many cases, however, the recommendations are often a poor fit for the receiving user. For example, a recommendation may be for a position that is below the receiving user's current position. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows an example system for extracting title hierarchy from career trajectory data, according to some example embodiments.

FIG. 2 is a block diagram of a recommendation system, according to some example embodiments.

FIG. 3 is a block diagram of a title hierarchy generation module, according to some example embodiments.

FIG. 4 is a flowchart showing an example method of extracting title hierarchy from career trajectory data, according to certain example embodiments.

FIG. 5 is a flowchart showing an example method of assigning seniority values, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for extracting title hierarchy from career trajectory data. A title hierarchy provides a ranking or arrangement of employment titles indicating the seniority level of the employment titles in relation to each other. For example, the title hierarchy indicates the likely order of employment titles that career trajectories traverse, such as from junior engineer to engineer, to senior engineer, etc. The title hierarchy can be used to provide relevant employment recommendations to users. For example, a recommendation system may use the title hierarchy and a user's current employment title to identify positions that are in line with the user's current position, such as an open employment listing that is at the same level as the user's current position or a next step in the user's career trajectory.

The recommendation system extracts the title hierarchy from career trajectory data for a plurality of users. Career trajectory data is data describing the career history of a user, such as data describing the positions held by the users. For example, the career trajectory data includes the employment titles associated with the positions held by the user, the dates of employment, the companies associated with the employment, etc. The recommendation system uses the career trajectory data to determine an expected or likely progression of career titles during a career trajectory, which is in turn used to determine the title hierarchy.

To extract the title hierarchy, the recommendation system generates a graph of connected nodes based on the career trajectory data. For example, the recommendation system generates a distinct node in the graph for each unique employment title identified in the career trajectory data. The recommendation system establishes connections among pairs of nodes in the graph to indicate user transitions among the employment titles associated with the nodes. For example, the recommendation system creates a connection between a pair of nodes that indicates that at least one user transitioned from an employment title corresponding to a first node in the pair of nodes (e.g., the source node) to an employment title corresponding to the second node in the pair of nodes (e.g., the destination node). The recommendation system assigns edge values to each connection established between a pair of nodes based on the number of users that transitioned from the employment title associated with the source node to the employment title associated with the destination node. Accordingly, a connection indicating a highly common transition among employment titles will be assigned a higher edge value than a connection indicating a less common transition among employment titles.

The recommendation system uses the edge values to assign seniority values to each node in the graph. The seniority value indicates a relative seniority level of the employment title associated with the node in relation to the other employment levels. The recommendation system may assign the seniority values using a topological sort of the nodes in the graph. For example, the recommendation system identifies a node in the graph that has no incoming connections (e.g., the node is not the destination node in any of the pairs of nodes) and assigns an initial seniority value to the node. The recommendation system then removes the node from the graph and repeats the process with an incrementally higher seniority value. For example, the recommendation system identifies a node that has no incoming connections and assigns the node an incrementally higher seniority value. This process may be repeated until each node in the graph is assigned a seniority value.

In some instances, there may be no available nodes in the graph that have no incoming connections (e.g., each node in the graph has an incoming connection). In this situation, the recommendation system may remove connections from the graph until a node without an incoming connection is created. For example, the recommendation system may remove the connections based on the edge values assigned to the connection, such as by removing the connection with the lowest connection value until a node without any incoming connections is created.

This process can result in multiple outcomes. That is, the process may be performed by traversing different paths through the graph, thereby resulting in different assignments of seniority values to the nodes in the graph. The recommendation system may select one of the assignments of seniority values based on an overall score assigned to each assignment of seniority values. One goal of the seniority value assignment process may be to assign seniority values in a manner such that transitions among the employment titles progress from employment titles with a lower seniority value to a higher seniority value. The recommendation system may provide overall scores to each assignment of seniority values based on this goal. For example, the recommendation system may reduce the overall score for an assignment of seniority values based on each instance of a transition from an employment title with a higher seniority value to an employment title with a lower seniority value. The amount by which the overall score is reduced may be based on the edge value assigned to the connection between the pair of nodes.

The recommendation system may select the assignment of seniority values that has the highest overall score. The seniority values assigned to the employment titles are used to determine the title hierarchy. For example, the title hierarchy may progress from the employment title with the lowest seniority value to the employment title with the highest seniority value.

Extracting title hierarchy using this method provides several technical improvements over prior systems. For example, the resulting title hierarchy is of higher quality than through use of mother methods. Accordingly, the quality of data is improved as well as the quality of the any output provided on the data, such as recommendations. Further, use of the generated nodes, edge values and seniority values provide a faster and more efficient method by which the title hierarchy is determines. As a result, the perceived speed of the computing device is increases over previous methods.

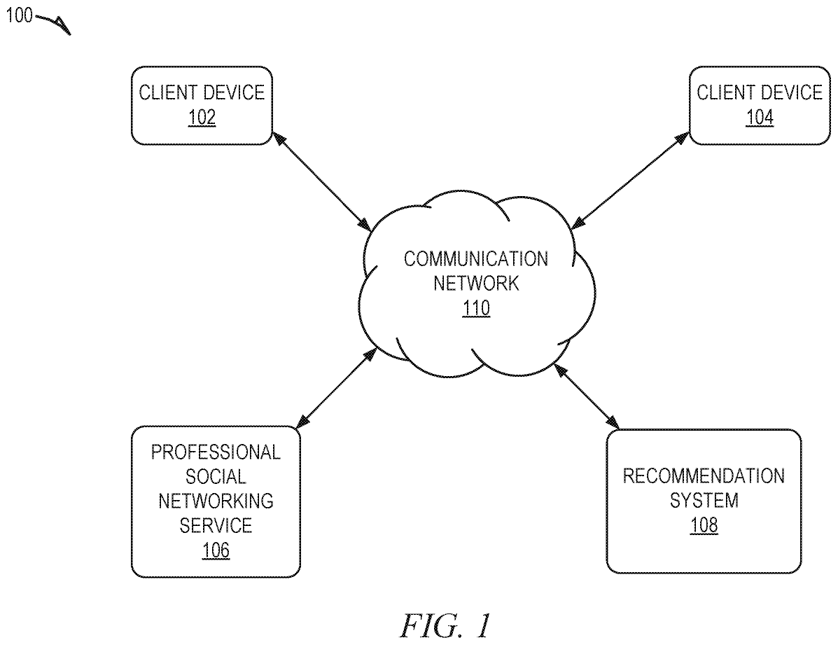

FIG. 1 shows an example system 100 for extracting title hierarchy from career trajectory data, according to some example embodiments. As shown, multiple devices (i.e., client device 102, client device 104, professional social networking service 106, and recommendation system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

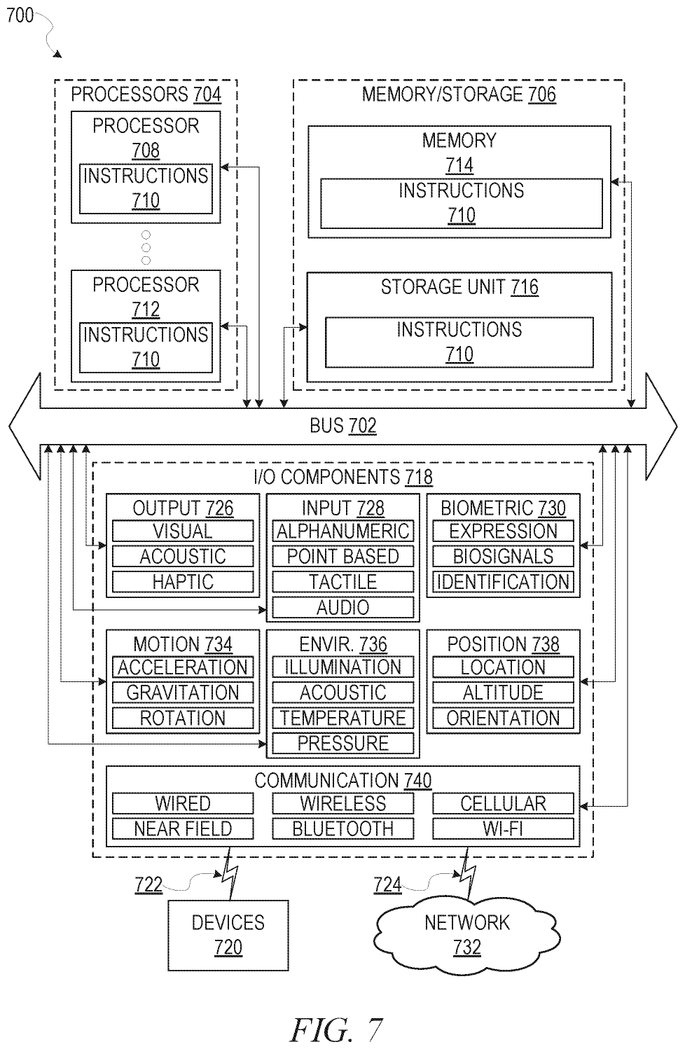

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the professional social networking service 106 to utilize the services provided by the professional social networking service 106. Users communicate with and utilize the functionality of the professional social networking service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the professional social networking service 106 may concurrently accept connections from and interact with any number of client devices 102, 104. The professional social networking service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the professional social networking service 106 via a client-side application installed on the client devices 102 and 104. In some embodiments, the client-side application includes a component specific to the professional social networking service 106. For example, the component may be a stand-alone application, one or more application plug-ins, and/or a browser extension. However, the users may also interact with the professional social networking service 106 via a third-party application, such as a web browser, that resides on the client devices 102 and 104 and is configured to communicate with the professional social networking service 106. In either case, the client-side application presents a user interface (UI) for the user to interact with the professional social networking service 106. For example, the user interacts with the professional social networking service 106 via a client-side application integrated with the file system or via a webpage displayed using a web browser application.

The professional social networking service 106 is one or more computing devices configured to provide a social networking service for business professionals that is accessible online (e.g., LINKEDIN). For example, the professional social networking service 106 allows a user to create users profiles including data describing each users' professional history, educational background, skills, etc. The professional social networking service 106 also enables users to view the profiles of other users, create connections with other users of the professional social networking service 106, post content (e.g., messages, articles, etc.), view content posted by other users, message other users, etc. The professional social networking service 106 may also provide job posting services that allows employers to post listings for job openings and allows users of the professional social networking service 106 to view the posted job listing and apply if so desired.

As part of its provided job posting service, the professional social networking service 106 may provide users with job recommendations. For example, users may be provided with messages that notify the user of jobs that may be of interest to the user, such as jobs openings that are within the user's field of work. Additionally, the recommended employment position may be of a seniority level that would be attractive to the user. For example, a user may be recommended employment positions that are at the same level as the user's current position or a common or logical next step in the user's career trajectory.

To provide job recommendations, the professional social networking service 106 utilizes the functionality of the recommendation system 108. Although the recommendation system 108 and the professional social networking service 106 are shown as separate entities, this is just for ease of explanation and is not meant to be limiting. In some embodiments, the recommendation system 108 is incorporated as part of the professional social networking service 106.

The recommendation system 108 is one or more computing device configured to generate employment recommendations for users. An employment recommendation is a message (e.g., email, direct message, etc.) that includes data about an available employment position that may be of interest to the receiving user. For example, the employment recommendation may include data such as the employer, job title, job description, salary range, etc. The employment recommendation may also include a link or to a listing for the employment position on the professional social networking service 106.

The recommendation system 108 generates employment recommendations for a user based on user profile data describing the user (e.g., the user's employment history, geographic location, education history, current salary, etc.) and employment data describing the employment listings (e.g., employment title, geographic location, etc.). For example, the recommendation system 108 identifies employment positions that are located within a specified geographic region of the user, are within the user's employment field, and that are of a seniority level that is attractive to the user given the user's current career trajectory. Accordingly, a user is provided with recommendations for open employment positions that are nearby the user and that are at the user's current level or a step forward in the user's career trajectory.

The recommendation system 108 determines whether an employment position is of a proper seniority level for a user based on a title hierarchy. A title hierarchy provides a ranking or arrangement of employment titles indicating the seniority level of the employment titles in relation to each other. For example, the title hierarchy indicates the likely order of employment titles that career trajectories traverse, such as from junior engineer to engineer, to senior engineer, etc. The title hierarchy can be used to provide relevant employment recommendations to users. For example, a recommendation system 108 may use the title hierarchy and a user's current employment title to identify employment positions that are in line with the user's current position, such as an open employment position that is at the same level as the user's current position or a next step in the user's career trajectory.

The recommendation system 108 may extract the title hierarchy from career trajectory data for a plurality of users. Career trajectory data is data describing the career history of a user, such as data describing the positions held by the users. For example, the career trajectory data includes the employment titles associated with the positions held by the user, the dates of employment, the companies associated with the employment, etc. The recommendation system 108 may gather the career trajectory data from the professional social networking service 106. For example, the user profiles for users of the professional social networking service 106 includes the career trajectory data for the user. The recommendation system 108 uses the career trajectory data to determine an expected or likely progression of career titles during a career trajectory, which is in turn used to determine the title hierarchy.

To extract the title hierarchy, the recommendation system 108 generates a graph of connected nodes based on the career trajectory data. For example, the recommendation system 108 generates a distinct node in the graph for each unique employment title identified in the career trajectory data. The recommendation system 108 establishes connections among pairs of nodes in the graph to indicate user transitions among the employment titles associated with the nodes. For example, the recommendation system 108 creates a connection between a pair of nodes that indicates that at least one user transitioned from an employment title corresponding to a first node in the pair of nodes (e.g., the source node) to an employment title corresponding to the second node in the pair of nodes (e.g., the destination node). The recommendation system 108 assigns edge values to each connection established between a pair of nodes based on the number of users that transitioned from the employment title associated with the source node to the employment title associated with the destination node. Accordingly, a connection indicating a highly common transition among employment titles will be assigned a higher edge value than a connection indicating a less common transition among employment titles.

The recommendation system 108 uses the edge values to assign seniority values to each node in the graph. The seniority value indicates a relative seniority level of the employment title associated with the node in relation to the other employment levels. The recommendation system 108 may assign the seniority values using a topological sort of the nodes in the graph. For example, the recommendation system 108 identifies a node in the graph that has no incoming connections (e.g., the node is not the destination node in any of the pairs of nodes) and assigns an initial seniority value to the node. The recommendation system 108 then removes the node from the graph and repeats the process with an incrementally higher seniority value. For example, the recommendation system 108 identifies a node that has no incoming connections and assigns the node an incrementally higher seniority value. This process may be repeated until each node in the graph is assigned a seniority value.

In some instances, there may be no available nodes in the graph that have no incoming connections (e.g., each node in the graph has an incoming connection). In this situation, the recommendation system 108 may remove connections from the graph until a node without an incoming connection is created. For example, the recommendation system 108 may remove the connections based on the edge values assigned to the connection, such as by removing the connection with the lowest connection value until a node without any incoming connections is created.

This process can result in multiple outcomes. That is, the process may be performed by traversing different paths through the graph, thereby resulting in different assignments of seniority values to the nodes in the graph. The recommendation system 108 may select one of the assignments of seniority values based on an overall score assigned to each assignment of seniority values. One goal of the seniority value assignment process may be to assign seniority values in a manner such that transitions among the employment titles progress from employment titles with a lower seniority value to a higher seniority value. The recommendation system 108 may determine overall scores to each assignment of seniority values based on this goal. For example, the recommendation system 108 may reduce the overall score (e.g., assign a penalty) for an assignment of seniority values based on each instance of a transition from an employment title with a higher seniority value to an employment title with a lower seniority value. The amount by which the overall score is reduced may be based on the edge value assigned to the connection between the pair of nodes. Accordingly, an instance of a transition from a higher seniority value to a lower seniority value that is associated with a low edge score will have a smaller impact on the overall score than an instance of a transition from a higher seniority value to a lower seniority value that is associated with a higher edge score.

The recommendation system 108 may select the assignment of seniority values that has the highest overall score. The seniority values assigned to the employment titles are used to determine the title hierarchy. For example, the title hierarchy may progress from the employment title with the lowest seniority value to the employment title with the highest seniority value.

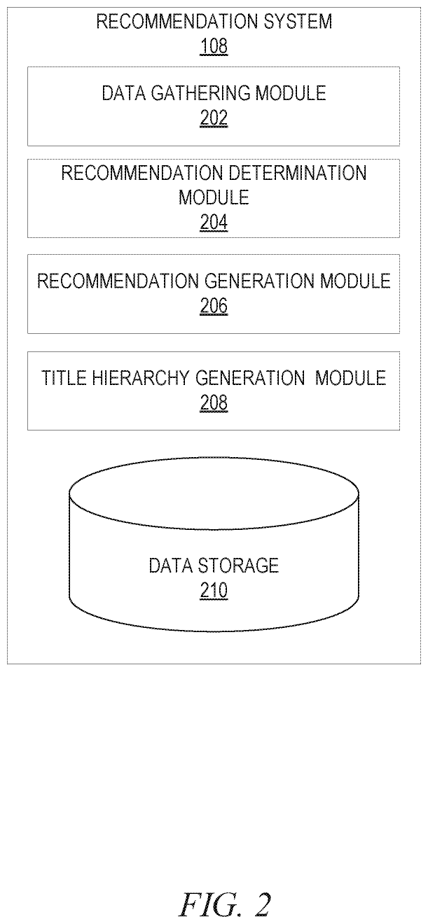

FIG. 2 is a block diagram of a recommendation system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the recommendation system 108 to facilitate additional functionality that is not specifically described herein. Furthermore, the various functional modules depicted in FIG. 2 may reside on a single computing device or may be distributed across several computing devices in various arrangements such as those used in cloud-based architectures.

As shown, the recommendation system 108 includes a data gathering module 202, a recommendation determination module 204, a recommendation generation module 206, a title hierarchy generation module 208, and a data storage 210.

The data gathering module 202 gathers data used by the other modules of the recommendation system 108. For example, the data gathering module 202 gathers user profile data for users of the professional social networking service 106. The user profile data includes data describing users, such as the users address, name, age, sex, etc. The user profile data also includes career trajectory data describing the user's career history. For example, the career trajectory data includes data describing employment positions held by the user in the past and currently, such as the dates of employment, the title of the employment positions (e.g., employment title), the companies at which the employment position was held, etc. The data gathering module 202 may also gather employment data for employment listings posted to the professional social networking service 106. The employment data includes data describing the listed employment positions, such as the geographic location of the employment position, the title of the position, the company offering the employment position, etc.

The data gathering module 202 gathers the user profile data and the employment data from the data storage 210 and/or from the professional social networking service 106. For example, in embodiments in which the recommendation system 108 is incorporates as part of the professional social networking service 106, the data storage may maintain the user profile data and the employment data. In other embodiments, however, the professional social networking service 106 may store the user profile data and the employment data in a data storage maintained by the professional social networking service 106. The data gathering module 202 may communicate with the professional social networking service 106 to gather the user profile data and the employment data.

The recommendation determination module 204 determines an employment position to recommend to a user. The recommendation determination module 204 determines which employment positions to recommend to a user based on user profile data describing the user (e.g., the user's employment history, geographic location, education history, current salary, etc.) and employment data describing the employment listings (e.g., employment title, geographic location, etc.). For example, the recommendation determination module 204 identifies employment positions that are located within a specified geographic region of the user, are within the user's employment field, and that are of a seniority level that is attractive to the user given the user's current career trajectory. Accordingly, a user is provided with recommendations for open employment positions that are nearby the user and that are at the user's current level or a step forward in the user's career trajectory.

The recommendation determination module 204 determines whether an employment position is of a proper seniority level for a user based on a title hierarchy. A title hierarchy provides a ranking or arrangement of employment titles indicating the seniority level of the employment titles in relation to each other. For example, the title hierarchy indicates the likely order of employment titles that career trajectories traverse, such as from junior engineer to engineer, to senior engineer, etc. The recommendation determination module 204 uses the title hierarchy to provide relevant employment recommendations to users. For example, a recommendation determination module 204 may use the title hierarchy and a user's current employment title to identify employment positions that are in line with the user's current position, such as an open employment position that is at the same level as the user's current position or a next or logical step in the user's career trajectory.

The recommendation generation module 206 generates a recommendation for a user based on the employment position determined by the recommendation determination module 204. For example, the recommendation generation module 206 generates a message that includes data describing the recommended employment position, such as the employer, employment title, employment description, salary range, etc. The employment recommendation may also include a link to a listing for the employment position posted to the professional social networking service 106. The recommendation generation module 206 may transmit the generated recommendation to the user, such as by sending an email, direct message, etc. Alternatively, the recommendation generation module 206 may provide the generated recommendation to the professional social networking service 106 and the professional social networking service sends the recommendation to the user.

The title hierarchy generation module 208 generates a title hierarchy from career trajectory data for a plurality of users. Career trajectory data is data describing the career history of a user, such as data describing the positions held by the users. For example, the career trajectory data includes the employment titles associated with the positions held by the user, the dates of employment, the companies associated with the employment, etc.

The title hierarchy generation module 208 generates the title hierarchy using a graph of connected nodes generated based on the career trajectory data. For example, the title hierarchy generation module 208 generates a distinct node in the graph for each unique employment title identified in the career trajectory data and establishes connections among pairs of nodes in the graph to indicate user transitions among the employment titles associated with the nodes. The title hierarchy generation module 208 assigns edge values to each connection established between a pair of nodes based on the number of users that transitioned from the employment title associated with the source node to the employment title associated with the destination node. The title hierarchy generation module 208 uses the edge values to assign seniority values to each node in the graph. For example, the title hierarchy generation module 208 assigns the seniority values using a topological sort of the nodes in the graph.

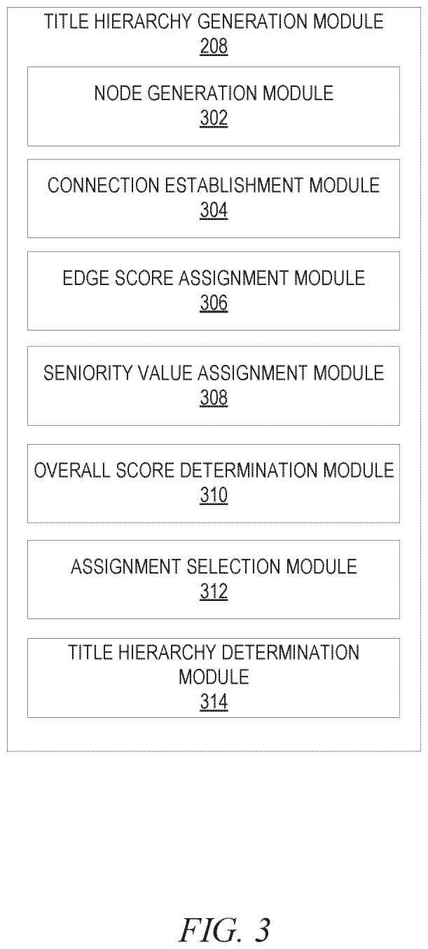

The topological sort may result in multiple assignments of seniority values to the nodes in the graph. The title hierarchy generation module 208 selects one of these assignments based on an overall score assigned to each assignment. For example, the title hierarchy generation module 208 determines an overall score for each assignment of seniority values based whether transitions among the employment titles meet a goal of progressing from employment titles with a lower seniority value to a higher seniority value. For example, the title hierarchy generation module 208 may reduce the overall score (e.g., assign a penalty) for an assignment of seniority values based on each instance of a transition from an employment title with a higher seniority value to an employment title with a lower seniority value. The amount by which the overall score is reduced may be based on the edge value assigned to the connection between the pair of nodes. The title hierarchy generation module 208 selects the assignment of seniority values that has the highest overall score. The functionality of the title hierarchy generation module 208 is described in greater detail below in relation to FIG. 3.

FIG. 3 is a block diagram of a title hierarchy generation module 208, according to some example embodiments. To avoid obscuring the inventive subject matter with unnecessary detail, various functional components (e.g., modules) that are not germane to conveying an understanding of the inventive subject matter have been omitted from FIG. 3. However, a skilled artisan will readily recognize that various additional functional components may be supported by the title hierarchy generation module 208 to facilitate additional functionality that is not specifically described herein. Furthermore, the various functional modules depicted in FIG. 3 may reside on a single computing device or may be distributed across several computing devices in various arrangements such as those used in cloud-based architectures.

As shown, the title hierarchy generation module 208 includes a node generation module 302, a connection establishment module 304, an edge score assignment module 306, a seniority value assignment module 308, an overall score determination module 310, an assignment selection module 312 and a title hierarchy determination module 314.

The node generation module 302 generates a node in a graph for each employment title identified in the career trajectory data. The node generation module 302 parses the career trajectory data to identify each unique employment title included in the career trajectory data. In some embodiments, the node generation module 302 normalizes the employment titles to combine similar or like employment titles. For example, the node generation module 302 may normalize employment titles to combine employment titles that have slight spelling variations or misspellings.

The node generation module 302 may generate nodes from a subset of career trajectory data that is specific to a single industry, such as Engineering, HR, etc. Accordingly, the extracted employment titles and generated nodes are specific to the industry, rather than employment titles from across multiple industries. The node generation module 302 may perform the process of identifying the employment titles and generating nodes for each industry, resulting in sets of nodes in a graph that are specific to each industry. This allows a separate title hierarchy to be generated per industry, however, the node generation module 302 may also perform this process with employment titles from multiple industries if desired.

The connection establishment module 304 generates connections between pairs of nodes in the graph based on the employment trajectory data. The connection between each pair of nodes indicates that users transitioned from an employment title associated with a source node of the pair of nodes to an employment tile associated with a destination node of the pair of nodes. The connection establishment module 304 identifies transitions between the employment titles from the employment trajectory data and establishes a connection between the nodes corresponding to the employment titles. For example, the connection establishment module 304 may identify that a user transition from a position as a junior engineer to a position as a senior engineer, and then establish a connection between the node in graph corresponding to junior engineer and the node in graph corresponding to senior engineer. The established connection indicates a direction of the transition, such as from the source node corresponding to junior engineer to the destination node corresponding to senior engineer.

In some instances, two connections may be established between a pair of nodes indicating that users have transitioned both ways among the employment titles. For example, some users may have transitioned from a position as a junior engineer to a senior engineer, while other users transitioned from senior engineer to junior engineer. In this case, the connection establishment module 304 may establish two connections between the pair of nodes in which each node is the source node of one of the connections and the destination node of the other connection.

In some embodiments, the connection establishment module 304 may establish a connection for each detected transition between employment titles. Alternatively, in some embodiments, the connection establishment module 304 may establish connections between nodes based on a set of criteria being met in addition to the detected transition between the employment titles. For example, the criteria may include a threshold number of users having made the transition among employment titles, users having held each employment title for a threshold period of time, etc. These additional criteria may eliminate unwanted data points, such as uncommon transitions.

The edge score assignment module 306 assigns edge values to each connection established by the connection establishment module 304. The edge value is a value indicating a relative strength of the connection. That is, the edge value indicates how common a transition is between the employment titles associated with the connected pair of nodes. A higher edge value indicates a stronger connection between the nodes, meaning that users transitioning between the employment titles is relative common. Alternatively, a lower edge value indicates a weaker connection between the nodes, meaning that users transitioning between the employment titles is relative uncommon.

The edge score assignment module 306 determines the edge score for a connection based on the number of users that made the transition represented by the connection. For example, in some embodiments, the edge score may be the number of users that made the transition represented by the connection, such as the number of users that transitioned from the employment title of the source node to the employment title of the destination node. Alternatively, the edge score assignment module 306 may calculate the edge score based on the number of users that made the transition represented by the connection, such as by applying weights based on an amount of time users stayed at each position, etc. In some embodiments, connections with an edge score below a threshold may be removed from the graph.

The seniority value assignment module 308 assigns seniority values to the nodes in the graph. The seniority value assigned to a node indicates a relative seniority level of the employment title associated with the node in relation to the other employment titles. The seniority value assignment module 308 may assign the seniority values using a topological sort of the nodes in the graph. For example, the seniority value assignment module 308 identifies a node in the graph that has no incoming connections (e.g., the node is not the destination node in any of the pairs of nodes) and assigns an initial seniority value to the node. The seniority value assignment module 308 then removes the node from the graph and repeats the process with an incrementally higher seniority value. For example, the seniority value assignment module 308 identifies another node that has no incoming connections and assigns the node an incrementally higher seniority value. This process may be repeated until each node in the graph is assigned a seniority value.

In some instances, there may be no available nodes in the graph that have no incoming connections (e.g., each node in the graph has an incoming connection). In this situation, the seniority value assignment module 308 may remove connections from the graph until a node without an incoming connection is created. For example, the seniority value assignment module 308 may remove connections based on the edge values assigned to the connection, such as by removing the connection with the lowest connection value until a node without any incoming connections is created.

This process can result in multiple outcomes. That is, the process may be performed by traversing different paths through the graph, thereby resulting in different assignments of seniority values to the nodes in the graph. The overall score determination module 310 provides an overall score to each resulting assignment of seniority values. One goal of the seniority value assignment process may be to assign seniority values in a manner such that transitions among the employment titles progress from employment titles with a lower seniority value to a higher seniority value. The overall score determination module 310 determines the overall scores for each assignment of seniority values based on this goal. For example, the overall score determination module 310 may reduce the overall score (e.g., assign a penalty) for an assignment of seniority values based on each instance of a transition from an employment title with a higher seniority value to an employment title with a lower seniority value. The amount by which the overall score determination module 310 reduces the overall score may be based on the edge value assigned to the connection between the pair of nodes. Accordingly, an instance of a transition from a higher seniority value to a lower seniority value that is associated with a low edge score will have a smaller impact on the overall score than an instance of a transition from a higher seniority value to a lower seniority value that is associated with a higher edge score.

The assignment selection module 312 select one of the assignments based on the overall score assigned to each assignment of seniority values. For example, the assignment selection module 312 selects the assignment of seniority values with the highest overall score. The title hierarchy determination module 314 determines the title hierarchy based on the selected assignment of seniority values. For example, the title hierarchy determination module 314 determines the title hierarchy to progress from the employment title with the lowest seniority value the employment title with the highest seniority value.

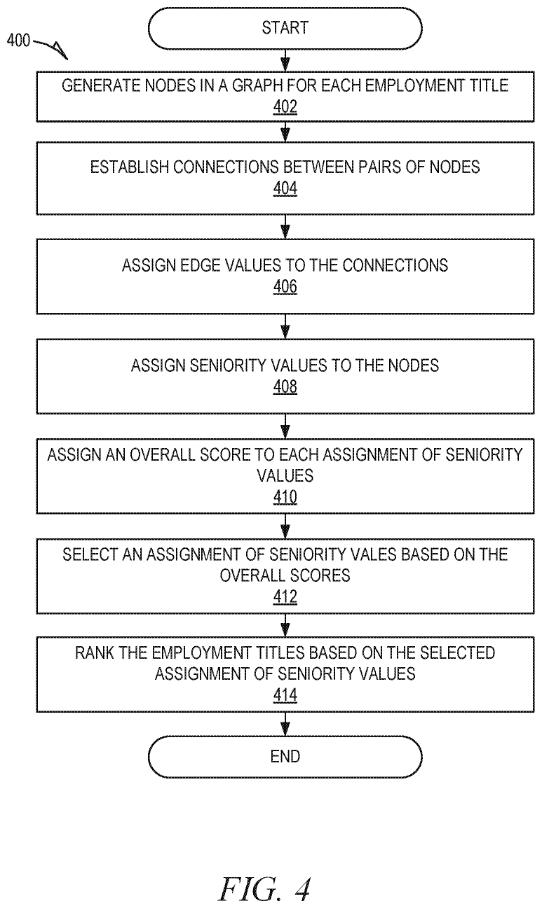

FIG. 4 is a flowchart showing an example method 400 of extracting title hierarchy from career trajectory data, according to certain example embodiments. The method 400 may be embodied in computer readable instructions for execution by one or more processors such that the operations of the method 400 may be performed in part or in whole by the recommendation system 108; accordingly, the method 400 is described below by way of example with reference thereto. However, it shall be appreciated that at least some of the operations of the method 400 may be deployed on various other hardware configurations and the method 400 is not intended to be limited to the recommendation system 108.

At operation 402, the node generation module 302 generates nodes in a graph for each employment title identified in career trajectory data. The node generation module 302 parses the career trajectory data to identify each unique employment title included in the career trajectory data. In some embodiments, the node generation module 302 normalizes the employment titles to combine similar or like employment titles. For example, the node generation module 302 may normalize employment titles to combine employment titles that have slight spelling variations or misspellings.

The node generation module 302 may generate nodes from a subset of career trajectory data that is specific to a single industry, such as Engineering, HR, etc. Accordingly, the extracted employment titles and generated nodes are specific to the industry, rather than employment titles from across multiple industries. The node generation module 302 may perform the process of identifying the employment titles and generating nodes for each industry, resulting in sets of nodes in a graph that are specific to each industry. This allows a separate title hierarchy to be generated per industry, however, the node generation module 302 may also perform this process with employment titles from multiple industries if desired.

At operation 404, the connection establishment module 304 establishes connections between pairs of nodes. The connection between each pair of nodes indicates that users transitioned from an employment title associated with a source node of the pair of nodes to an employment tile associated with a destination node of the pair of nodes. The connection establishment module 304 identifies transitions between the employment titles from the employment trajectory data and establishes a connection between the nodes corresponding to the employment titles. For example, the connection establishment module 304 may identify that a user transition from a position as a junior engineer to a position as a senior engineer, and then establish a connection between the node in graph corresponding to junior engineer and the node in graph corresponding to senior engineer. The established connection indicates a direction of the transition, such as from the source node corresponding to junior engineer to the destination node corresponding to senior engineer.

In some instances, two connections may be established between a pair of nodes indicating that users have transitioned both ways among the employment titles. For example, some users may have transitioned from a position as a junior engineer to a senior engineer, while other users transitioned from senior engineer to junior engineer. In this case, the connection establishment module 304 may establish two connections between the pair of nodes in which each node is the source node of one of the connections and the destination node of the other connection.

In some embodiments, the connection establishment module 304 may establish a connection for each detected transition between employment titles. Alternatively, in some embodiments, the connection establishment module 304 may establish connections between nodes based on a set of criteria being met in addition to the detected transition between the employment titles. For example, the criteria may include a threshold number of users having made the transition among employment titles, users having held each employment title for a threshold period of time, etc. These additional criteria may eliminate unwanted data points, such as uncommon transitions.

At operation 406, the edge score assignment module 306 assigns edge values to the connections. The edge value is a value indicating a relative strength of the connection. That is, the edge value indicates how common a transition is between the employment titles associated with the connected pair of nodes. A higher edge value indicates a stronger connection between the nodes, meaning that users transitioning between the employment titles is relative common. Alternatively, a lower edge value indicates a weaker connection between the nodes, meaning that users transitioning between the employment titles is relative uncommon.

The edge score assignment module 306 determines the edge score for a connection based on the number of users that made the transition represented by the connection. For example, in some embodiments, the edge score may be the number of users that made the transition represented by the connection, such as the number of users that transitioned from the employment title of the source node to the employment title of the destination node. Alternatively, the edge score assignment module 306 may calculate the edge score based on the number of users that made the transition represented by the connection, such as by applying weights based on an amount of time users stayed at each position, etc. In some embodiments, connections with an edge score below a threshold may be removed from the graph.

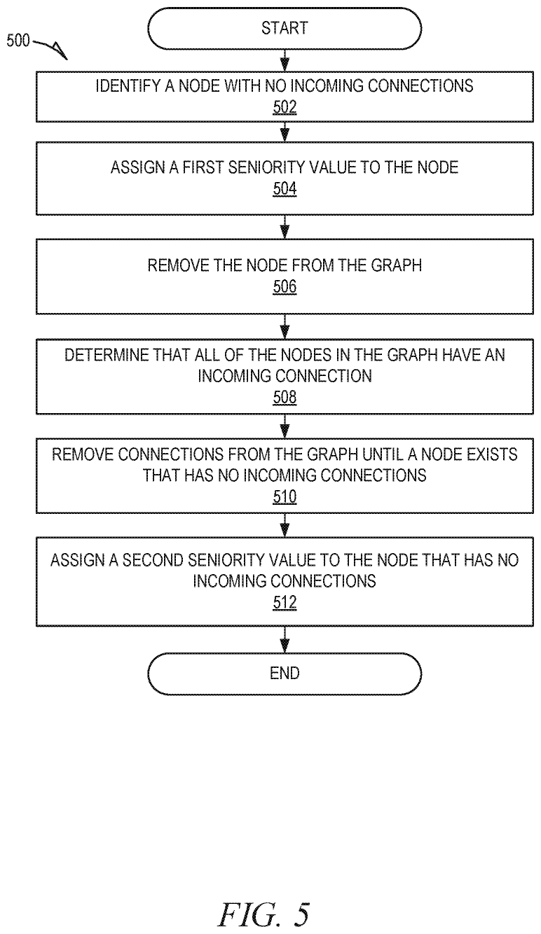

At operation 408, the seniority value assignment module 308 assigns seniority values to the nodes. The seniority value assigned to a node indicates a relative seniority level of the employment title associated with the node in relation to the other employment titles. The seniority value assignment module 308 may assign the seniority values using a topological sort of the nodes in the graph. For example, the seniority value assignment module 308 may use a method as described below in relation to FIG. 5

The seniority value assignment module 308 may provide multiple outcomes. That is, the process may be performed by traversing different paths through the graph, thereby resulting in different assignments of seniority values to the nodes in the graph. Accordingly, at operation 410, the overall score determination module 310 assigns an overall score to each resulting assignment of seniority values. One goal of the seniority value assignment process may be to assign seniority values in a manner such that transitions among the employment titles progress from employment titles with a lower seniority value to a higher seniority value. The overall score determination module 310 determines the overall scores for each assignment of seniority values based on this goal. For example, the overall score determination module 310 may reduce the overall score (e.g., assign a penalty) for an assignment of seniority values based on each instance of a transition from an employment title with a higher seniority value to an employment title with a lower seniority value. The amount by which the overall score determination module 310 reduces the overall score may be based on the edge value assigned to the connection between the pair of nodes. Accordingly, an instance of a transition from a higher seniority value to a lower seniority value that is associated with a low edge score will have a smaller impact on the overall score than an instance of a transition from a higher seniority value to a lower seniority value that is associated with a higher edge score.

At operation 412, the assignment selection module 312 selects one of the assignments based on the overall score assigned to each assignment of seniority values. For example, the assignment selection module 312 selects the assignment of seniority values with the highest overall score.

At operation 414, the title hierarchy determination module 314 ranks the employment titles based on the selected assignment of seniority values. For example, the title hierarchy determination module 314 ranks the employment titles from the employment title with the lowest seniority value the employment title with the highest seniority value. The resulting ranking is used as the title hierarchy.

FIG. 5 is a flowchart showing an example method 500 of assigning seniority values, according to certain example embodiments. The method 500 may be embodied in computer readable instructions for execution by one or more processors such that the operations of the method 500 may be performed in part or in whole by the recommendation system 108; accordingly, the method 500 is described below by way of example with reference thereto. However, it shall be appreciated that at least some of the operations of the method 500 may be deployed on various other hardware configurations and the method 500 is not intended to be limited to the recommendation system 108.

At operation 502, the seniority value assignment module 308 identifies a node with no incoming connections.

At operation 504, the seniority value assignment module 308 assigns a first seniority value to the node.

At operation 506, the seniority value assignment module 308 removes the node from the graph.

At operation 508, the seniority value assignment module 308 determines that all of the nodes in the graph have incoming connections.

At operation 510, the seniority value assignment module 308 removes connections from the graph until a node exists that has no incoming connections. For example, the seniority value assignment module 308 may remove connections based on the edge values assigned to the connection, such as by removing the connection with the lowest connection value until a node without any incoming connections is created.

At operation 512, the seniority value assignment module 308 assigns a second seniority value to the node that has no incoming connections. For example, the second seniority value may be an incrementally higher seniority value than the first seniority value. This process may be repeated until each node in the graph is assigned a seniority value.

### Software Architecture

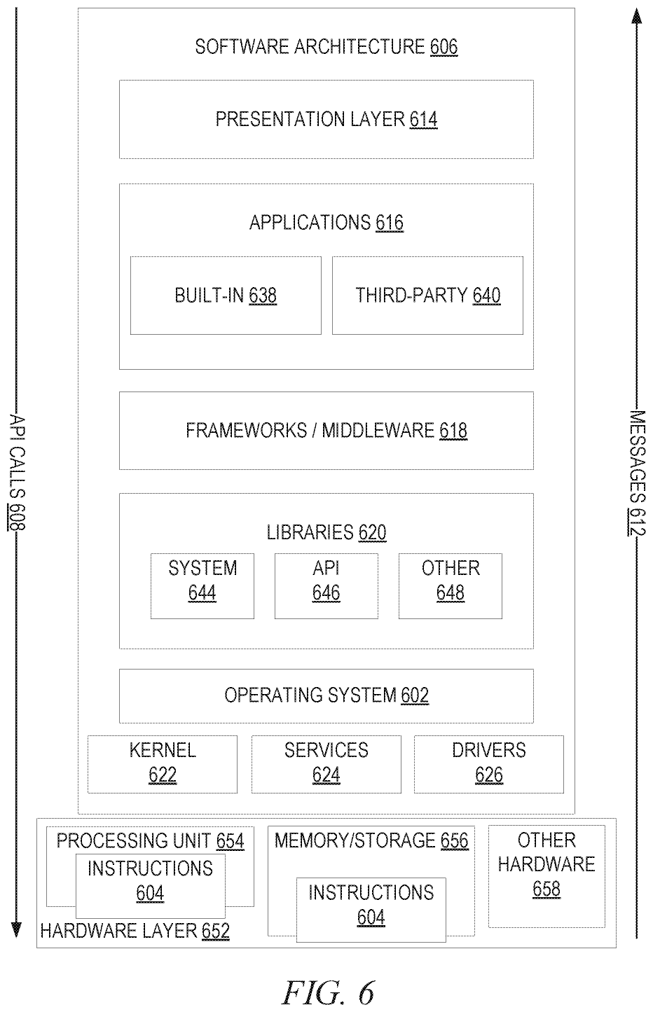

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke application programming interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or JQ™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and 1/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740 such as location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices 102, 104. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor 704) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor 704 may further be a multi-core processor having two or more independent processors 704 (sometimes referred to as “cores”) that may execute instructions 710 contemporaneously.

What is claimed is:

1. A method comprising:
for each employment title from a set of employment titles, generating a distinct node in a graph, each employment title from the set of employment titles derived from employment trajectory data for a set of users;
establishing connections between pairs of distinct nodes in the graph, each respective pair of distinct nodes including a source node and a destination node, wherein a connection established between a respective pair of distinct nodes indicates that at least one of the users from the set of users transitioned from a source employment title corresponding to the source node of the respective pair of distinct nodes to a destination employment title corresponding to the destination node of the respective pair of distinct nodes;
assigning edge values to each connection established between the pairs of distinct nodes in the graph, where each edge value is determined based on a number of users from the set of users that transitioned from the source employment title corresponding to the source node from the respective pair of distinct nodes to the destination employment title corresponding to the destination node from the respective pair of distinct nodes;
assigning, based on the edge values assigned to each connection established between the pairs of distinct nodes in the graph, a seniority value to each distinct node in the graph, yielding a set of seniority values; and
ranking the set of employment titles based on the set of seniority values.

2. The method of claim 1, wherein assigning the seniority value to each distinct node in the graph comprises:
assigning a first seniority value to a first distinct node in the graph, the first distinct node being included in a first pair of distinct nodes with a second distinct node, the second distinct node being the destination node in the first pair of distinct nodes; and
assigning a second seniority value to the second distinct node in the graph, the second seniority value being greater than the first seniority value.

3. The method of claim 2, wherein the first distinct node is not the destination node in any of the pairs of distinct nodes in the graph.

4. The method of claim 2, further comprising:
identifying a third distinct node in the graph, the third distinct node being included in a second pair of distinct nodes with the second distinct node, the third distinct node being the destination node in the second pair of distinct nodes; and
assigning a third seniority value to the third distinct node, the third seniority value being greater than the second seniority value.

5. The method of claim 1, further comprising:
assigning, based on the edge values assigned to each connection established between the pairs of distinct nodes in the graph, a second seniority value to each distinct node in the graph, yielding a second set of seniority values; and
determining a first overall score for the first set of seniority values;
determining a second overall score for the second set of seniority values; and
selecting the first set of seniority values based on a comparison of the first overall score and the second overall score.

6. The method of claim 5, wherein determining the first overall score comprises:
determining that a first seniority value from the first set of seniority values that is assigned to a source node in a first pair of distinct nodes in the graph is higher than a second seniority value from the first set of seniority values that is assigned to a destination node in the first pair of distinct nodes, yielding a first determination; and
applying a penalty to the first overall score based on the first determination.

7. The method of claim 6, wherein the penalty is based on an edge value assigned to a connection between the first pair of distinct nodes.

8. A computing system comprising:
one or more computer processors; and
one or more computer-readable mediums storing instructions that, when executed by the one or more computer processors, cause the computing system to perform operations comprising:
for each employment title from a set of employment titles, generating a distinct node in a graph, each employment title from the set of employment titles derived from employment trajectory data for a set of users;
establishing connections between pairs of distinct nodes in the graph, each respective pair of distinct nodes including a source node and a destination node, wherein a connection established between a respective pair of distinct nodes indicates that at least one of the users from the set of users transitioned from a source employment title corresponding to the source node of the respective pair of distinct nodes to a destination employment title corresponding to the destination node of the respective pair of distinct nodes;
assigning edge values to each connection established between the pairs of distinct nodes in the graph, where each edge value is determined based on a number of users from the set of users that transitioned from the source employment title corresponding to the source node from the respective pair of distinct nodes to the destination employment title corresponding to the destination node from the respective pair of distinct nodes;
assigning, based on the edge values assigned to each connection established between the pairs of distinct nodes in the graph, a seniority value to each distinct node in the graph, yielding a set of seniority values; and
ranking the set of employment titles based on the set of seniority values.

9. The computing system of claim 8, wherein assigning the seniority value to each distinct node in the graph comprises:
assigning a first seniority value to a first distinct node in the graph, the first distinct node being included in a first pair of distinct nodes with a second distinct node, the second distinct node being the destination node in the first pair of distinct nodes; and
assigning a second seniority value to the second distinct node in the graph, the second seniority value being greater than the first seniority value.

10. The computing system of claim 9, wherein the first distinct node is not the destination node in any of the pairs of distinct nodes in the graph.

11. The computing system of claim 9, the operations further comprising:
identifying a third distinct node in the graph, the third distinct node being included in a second pair of distinct nodes with the second distinct node, the third distinct node being the destination node in the second pair of distinct nodes; and
assigning a third seniority value to the third distinct node, the third seniority value being greater than the second seniority value.

12. The computing system of claim 8, the operations further comprising:
assigning, based on the edge values assigned to each connection established between the pairs of distinct nodes in the graph, a second seniority value to each distinct node in the graph, yielding a second set of seniority values; and
determining a first overall score for the first set of seniority values;
determining a second overall score for the second set of seniority values; and
selecting the first set of seniority values based on a comparison of the first overall score and the second overall score.

13. The computing system of claim 12, wherein determining the first overall score comprises:
determining that a first seniority value from the first set of seniority values that is assigned to a source node in a first pair of distinct nodes in the graph is higher than a second seniority value from the first set of seniority values that is assigned to a destination node in the first pair of distinct nodes, yielding a first determination; and
applying a penalty to the first overall score based on the first determination.

14. The computing system of claim 13, wherein the penalty is based on an edge value assigned to a connection between the first pair of distinct nodes.

15. A non-transitory computer-readable medium storing instructions that, when executed by one or more computer processors of a computing system, cause the computing system to perform operations comprising:
for each employment title from a set of employment titles, generating a distinct node in a graph, each employment title from the set of employment titles derived from employment trajectory data for a set of users;
establishing connections between pairs of distinct nodes in the graph, each respective pair of distinct nodes including a source node and a destination node, wherein a connection established between a respective pair of distinct nodes indicates that at least one of the users from the set of users transitioned from a source employment title corresponding to the source node of the respective pair of distinct nodes to a destination employment title corresponding to the destination node of the respective pair of distinct nodes;
assigning edge values to each connection established between the pairs of distinct nodes in the graph, where each edge value is determined based on a number of users from the set of users that transitioned from the source employment title corresponding to the source node from the respective pair of distinct nodes to the destination employment title corresponding to the destination node from the respective pair of distinct nodes;
assigning, based on the edge values assigned to each connection established between the pairs of distinct nodes in the graph, a seniority value to each distinct node in the graph, yielding a set of seniority values; and
ranking the set of employment titles based on the set of seniority values.

16. The non-transitory computer-readable medium of claim 15, wherein assigning the seniority value to each distinct node in the graph comprises:
assigning a first seniority value to a first distinct node in the graph, the first distinct node being included in a first pair of distinct nodes with a second distinct node, the second distinct node being the destination node in the first pair of distinct nodes; and
assigning a second seniority value to the second distinct node in the graph, the second seniority value being greater than the first seniority value.

17. The non-transitory computer-readable medium of claim 16, wherein the first distinct node is not the destination node in any of the pairs of distinct nodes in the graph.

18. The non-transitory computer-readable medium of claim 16, the operations further comprising:
identifying a third distinct node in the graph, the third distinct node being included in a second pair of distinct nodes with the second distinct node, the third distinct node being the destination node in the second pair of distinct nodes; and
assigning a third seniority value to the third distinct node, the third seniority value being greater than the second seniority value.

19. The non-transitory computer-readable medium of claim 15, the operations further comprising:
assigning, based on the edge values assigned to each connection established between the pairs of distinct nodes in the graph, a second seniority value to each distinct node in the graph, yielding a second set of seniority values; and
determining a first overall score for the first set of seniority values;
determining a second overall score for the second set of seniority values; and
selecting the first set of seniority values based on a comparison of the first overall score and the second overall score.

20. The non-transitory computer-readable medium of claim 19, wherein determining the first overall score comprises:
determining that a first seniority value from the first set of seniority values that is assigned to a source node in a first pair of distinct nodes in the graph is higher than a second seniority value from the first set of seniority values that is assigned to a destination node in the first pair of distinct nodes, yielding a first determination; and
applying a penalty to the first overall score based on the first determination, the penalty being based on an edge value assigned to a connection between the first pair of distinct nodes.
